(19) United States
(12) Patent Application Publication
(10) Pub. No.: US 2008/0035615 A1
(43) Pub. Date: Feb. 14, 2008

(54) Lap welding of steel articles having a corrosion resisting metallic coating

(75) Inventors: Xiaogang Li, Waterloo (CA); W.H. Scott Lawson, Guelph (CA); Y. Norman Zhou, Waterloo (CA)

Correspondence Address: PRIEST & GOLDSTEIN PLLC, 5015 SOUTHPARK DRIVE, SUITE 230, DURHAM, NC, 27713-7736, US

(73) Assignee: Y. Norman Zhou, Waterloo (CA)

(21) Appl. No.: 11/226,834

(22) Filed: Sep. 14, 2005

Related U.S. Application Data
(60) Provisional application No. 60/610,351, filed on Sep. 16, 2004.

(51) Int. Cl. B23K 26/24

(52) U.S. Cl. 219/121.63; 219/121.64

(57) ABSTRACT

Techniques are described for lap welding steel articles with a corrosion resistant coating. First and second steel members with a coating comprising zinc are welded together in a lap region. A metal selected to have a melting temperature below the boiling temperature of zinc, and to form a liquid alloy with the zinc, which alloy has a boiling temperature above the melting temperature of steel, is added to the lap region.

### FIELD OF THE INVENTION

The present invention generally relates to the field of welding of steel articles, such as steel sheets, and more particularly to advantageous techniques for welding steel articles having a corrosion resistant metallic coating.

### BACKGROUND OF THE INVENTION

Lap welding is a common method of assembling sheet metal structures. A lap weld is broadly defined as a weld between two overlapping materials such as sheets. Lap welding may be carried out, for example, by using a laser as a directed source of the concentrated heat energy needed to form a weld. In carrying out an exemplary laser welding process, two or more sheets of metal to be welded are clamped together, forming an assembly in a lap joint configuration. The metal surfaces that are tightly in contact, clamped for welding, are referred to as “faying surfaces.”

A concentrated heat source is then applied to one surface of the assembly, causing localized melting of materials in the assembly. If the depth of this melting progresses through the first metal sheet and into the second metal sheet or beyond, then the two metal sheets will locally coalesce. A weld nugget is thus formed once the heat source, such as a laser beam, has been moved along the joint or is turned off, allowing the locally melted zone to re-freeze.

Application of lap welding processes to fabricating products from steel materials having preapplied corrosion-resistant coatings, such as automobile bodies, is problematic. A common method of suppressing corrosion and rusting of steel is to coat steel surfaces with a layer of zinc or an alloy that is predominantly zinc, to a thickness of several micrometers (μm), typically from about 2 μm to about 20 μm. Such a zinc coating can be applied, for example, by momentarily dipping the steel into liquid zinc, known as “galvanizing.” Zinc melts at 420° C. and reaches its boiling point at 906° C. at normal atmospheric pressure, whereas steel melts at about 1530° C. Hence, if a laser lap weld is subsequently carried out on the zinc coated steel sheets, the zinc coating on the faying surfaces of the sheets will begin to boil as the faying surface area heats up over 906° C., before the steel at that location begins to melt. When the steel is heated toward temperatures where it begins to melt at the faying surface, zinc vapor having a very high gas pressure is generated between the steel sheets. The zinc vapor can bubble out through the molten steel at the faying surface, possibly explosively. This bubbling and explosive zinc vapor emission can disturb the small pool of liquid steel that is formed at the melted region and may eject the liquid steel from the desired joint region, thus weakening the weld. In an exemplary welding application, the heat source is moved along a path, leaving an elongated weld seam, which will likely have periodic holes or other gross defects, if the steel being welded was zinc coated.

Industries wishing to use laser lap welding of corrosion treated steel need a reliable method to mitigate or eliminate this problem. Several different technologies have been developed and explored to this end. The most commonly used technique for mitigating the zinc vapor problem is to arrange the lapped sheets so that a small physical gap having a controlled thickness exists between the lapped sheets at the desired welding location. In this manner, zinc vapor formed in the faying interface is not trapped and can be discharged laterally through the gap. Such a gap is difficult to create in a reproducible manner at the time of welding, even with special clamps and fixtures. Alternatively, the desired gap can be created before welding by the placement of spacers or shims, or by embossing of small projections upon one of the faying sheets. Regarding the latter method, see the following articles, the entirety of which are hereby incorporated herein by reference: M. P. Graham et al., Welding Journal Research Supplement, Vol. 75, No. 5, May 1996, pp. 162s-170s; and M. P. Graham, H. W. Kerr and D. C. Weckman, International Society for Optical Engineering (SPIE) Conference Proceedings, Vol. 2703, April 1996, pp. 170-183.

One alternative to provision of a physical path for escape of zinc vapor is to deactivate the escaping zinc by means of a physical or chemical reaction that takes place while the welding process is underway. In this manner, the localized zinc is intended to be converted into another substance that is substantially less volatile than zinc vapor.

For example, the possibility of adding oxygen to a shielding gas blanket around the weld area during the welding process has been suggested. See the following items, the entirety of which are hereby incorporated herein by reference: N. Karube, Y. Nakata and A. Mori, Proceedings of the 25^{th} ISATA International Symposium on Automotive Technology and Automation”, Florence, Italy 1992, Automotive Automation, Ltd., Croydon, UK, pp. 119-137; and A. Mori, Y. Nakata and E. Yamazaki, U.S. Pat. No. 5,539,180 issued Jul. 23, 1996, entitled “Method of Laser Beam Welding Galvanized Steel Sheets With an Auxiliary Gas Containing Oxygen.” During welding, an inert or substantially inert gas, usually argon or helium, is caused to flow over the weld area to protect the molten metal from oxidation. Oxygen can be deliberately added to this inert gas flow in hope of converting the volatile zinc to less volatile zinc oxide. This method has been shown to be somewhat effective. However, oxygen that is thus added to the welding environment will react not only with zinc vapor but also with iron and other elements present in the steel, which can cause some deterioration in the appearance and/or properties of the resultant weld.

Another method of reducing zinc vapor production by intentionally causing a desired chemical reaction is to coat the faying surfaces with powdered iron oxide. See, E. L. Baardsen, U.S. Pat. No. 3,969,604, issued Jul. 13, 1976, entitled “Method of Welding Galvanized Steel”, the entirety of which is hereby incorporated herein by reference. According to the process disclosed by Baardsen, the iron oxide will decompose during welding and the oxygen thus released will chemically combine with the zinc, forming zinc oxide.

In another method, a powdered metal having an affinity for zinc is injected into a molten steel weld pool between two faying surfaces, so as to bond chemically or metallurgically with the zinc coating of the surfaces. The only such powdered metal specifically disclosed is copper. See Speranza et al., U.S. Pat. No. 6,797,914, issued Sep. 28, 2004, entitled “Joining Workpieces by Laser Welding with Powder Injection,” the entirety of which is hereby incorporated herein by reference. Unfortunately, it is a dangerous strategy to try to add such a substance to the molten steel, because such additional substances can change the crystal structure and properties of the weld area, or cause spontaneous cracking during welding, if dissolved in the molten steel to an excessive extent. In particular, copper added to molten steel tends to make it crack on freezing, as further discussed below.

A welding method has also been disclosed that suggests that providing a coating of carbon-graphite in the faying interface can suppress zinc vapor bubble evolution. See, T. Arai, U.S. Pat. No. 5,183,991, issued Feb. 2, 1993, entitled “Method of Welding Galvanized Steel Sheets With a Laser Beam”, the entirety of which is hereby incorporated herein by reference. The physical mechanism by which the carbon material acts to accomplish this suppression is unclear.

In another known process, copper metal has been provided as a coating or a foil to the faying surface region, such added copper metal being intended to dissolve and form a metallic alloy with the zinc. See the following items, the entireties of which are hereby incorporated herein by reference: A. Dasgupta, J. Mazumder and M. Bembenek, Proceedings of ICALEO 2000, Symposium on Laser Applications in the Automotive Industry, Laser Institute of America, Orlando, Fla. 2000, pp. A-38-A-45; and J. Mazumder, A. Dasgupta and M. Bembenek, U.S. Pat. No. 6,479,168, issued on Nov. 12, 2002, entitled “Alloy Based Laser Welding.”

Copper is the only metal disclosed or suggested for use by these references in forming a metallic alloy with zinc. The alloy that forms by dissolution of zinc into copper, commonly known as brass, does have some metallurgical compatibility with steel, and is in fact used as a filler metal for brazing steel together. The term “brazing” originally meant to bond metals together using brass.

However, the melting temperature of copper is about 1083° C., which is above the boiling temperature of zinc. Hence, the problematic zinc will vaporize before the copper melts, detracting from the goal of trapping the zinc before zinc vapor release can damage the weld quality. Dissolution of the vaporized zinc into the copper to form a brass alloy having a higher boiling temperature than zinc will only occur slowly until the copper begins to melt. Hence, the zinc vapor is unlikely to be fully absorbed by the time that the faying surface area heats up to the steel melting temperature. Moreover, even very small amounts of copper used as a weld interlayer material have been found to cause weld solidification cracking. See, R. R. G. M. Pieters, R. Thiessen and I. M. Richardson, Laser Welding of Zinc Coated Steel in an Overlap Configuration, IIW Doc. IV-838-03, the entirety of which is hereby incorporated herein by reference.

### SUMMARY OF THE INVENTION

The present invention provides methods for welding together zinc coated steel articles such as steel sheets, comprising the interposition of an added metal during the welding process so that an alloy comprising the added metal and zinc is formed. The added metal, which preferably comprises aluminum, is introduced into the faying surface region in the form of coatings previously applied to the zinc coated steel sheets in the intended weld areas, or in the form of a foil inserted between the sheets to be welded. The added metal is selected to have a melting temperature below the boiling temperature of zinc, and to form a liquid alloy with zinc, which alloy has a boiling temperature above the melting temperature of steel. By supplying the material intended to react with zinc directly to the interfacial region of the lap joint, most of such material advantageously will react with the zinc and relatively little will end up dissolved in the steel.

The present invention further encompasses the resulting welded steel articles made by the methods of the invention.

In one embodiment according to the present invention, an apparatus is provided, comprising: first and second steel members; a coating comprising zinc on each of the first and second steel members; a weld bonding together the first and second steel members in a lap region; the lap region comprising an added metal selected to have a melting temperature below the boiling temperature of zinc, and to form a liquid alloy with zinc, which alloy has a boiling temperature above the melting temperature of steel. In a preferred embodiment, the added metal comprises aluminum.

In a further embodiment according to the present invention, a process for forming a lap weld is provided, comprising the following steps: providing first and second steel members to be lap welded together, each of the steel members having a coating thereon comprising zinc; defining first and second lap regions respectively of such first and second steel members to be welded together; juxtaposing the first and second lap regions together, having an amount of an added metal interposed therebetween in the form of an added coating, powder or foil sufficient to form an alloy with the zinc, the added metal selected to have a melting temperature below the boiling temperature of zinc, and to form a liquid alloy with zinc, which alloy has a boiling temperature above the melting temperature of steel; and heating the lap regions to a temperature sufficient to melt the added metal, form the alloy comprising the added metal and zinc, and weld together the first and second steel members in the lap region. In a preferred embodiment, the added metal comprises aluminum.

A more complete understanding of the present invention, as well as other features and advantages of the invention, will be apparent from the following detailed description and the accompanying drawings.

### BRIEF DESCRIPTION OF THE DRAWINGS

FIG. 1 shows two steel sheets welded together by a lap joint in accordance with the present invention;

FIG. 2 shows a section along line 2-2 of the lap joint of FIG. 1;

FIG. 3 shows a steel lap joint as it is being formed during an exemplary laser welding process; and

FIG. 4 shows a vertical section of the steel lap joint of FIG. 1, in which an aluminum foil is positioned to form an alloy with the zinc coating as it melts on the surfaces of the steel sheets during the welding process.

The drawings of the instant specification are not to scale but are merely schematic representations, and thus are not intended to portray the specific dimensions of the various embodiments according to the invention, which may be determined by skilled artisans through examination of the disclosure herein.

### DETAILED DESCRIPTION OF THE INVENTION

The present invention will now be described more fully with reference to the accompanying drawings, in which several presently preferred embodiments of the invention are shown. This invention may, however, be embodied in various forms and should not be construed as being limited to the embodiments set forth herein. Rather, these embodiments are provided so that this disclosure will be thorough and complete, and will fully convey the scope of the invention to those skilled in the art.

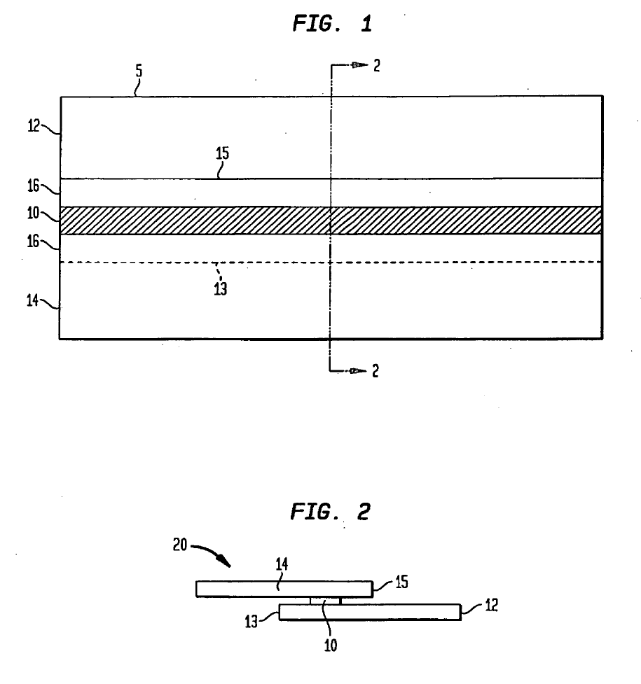

FIG. 1 shows a region 5 of two zinc galvanized steel sheets 12 and 14 that are bonded together by a lap weld 10 according to the present invention. The lap weld 10 bonds together the two galvanized steel sheets 12 and 14 in a lap weld region 16 in which the two galvanized steel sheets 12 and 14 overlap with each other. Steel sheet 14 has a visible leading edge 15. Steel sheet 12 has a leading edge 13 that is underneath steel sheet 14. The lap weld region 16 is defined by, and extends between, the respective leading edges 13 and 15 of the steel sheets 12 and 14. In this exemplary embodiment, the lap weld 10 is not coextensive with, and is more narrow than, the lap weld region 16, although the lap weld 10 and lap weld region 16 may be coextensive if desired. FIG. 2 shows a section 20, along line 2-2 in FIG. 1, of the region 5.

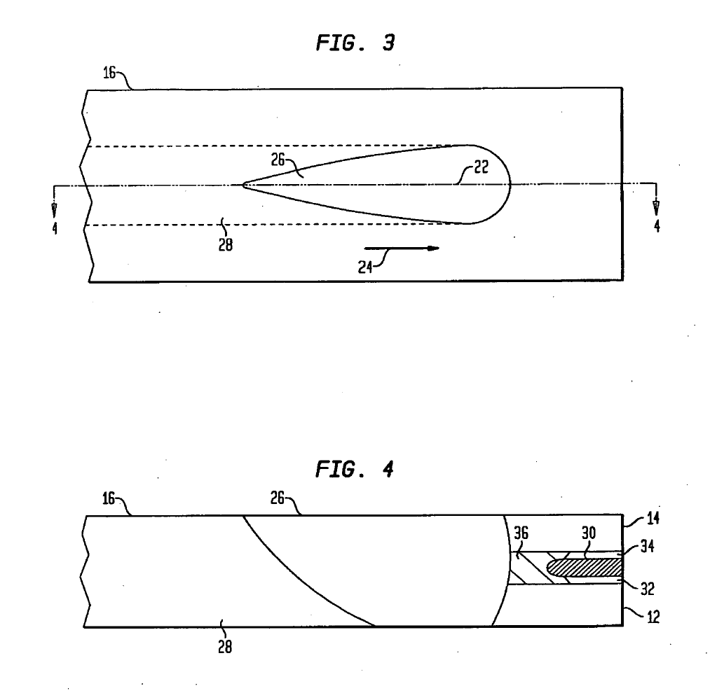

FIG. 3 shows a plan view of the steel lap weld 10 during its production using an exemplary laser welding process. FIG. 3 shows the lap region 16, so that the top of only a portion of one of the two galvanized steel sheets being welded together is shown coextensively with the lap region 16. The portion of the other steel sheet occupying the lap region 16 is directly below the portion of the top sheet occupying the lap region 16 as shown, and is not visible. A laser beam impacts the lap region 16 at point 22, and is moved in the direction 24. The impact of the laser beam creates a teardrop-shaped pool 26 of molten steel which also moves to the right, and a trailing solidified steel weld 28.

FIG. 4 shows a vertical section, along line 4-4 shown in FIG. 3, of the steel lap weld 10 during its production using an exemplary laser welding process according to the present invention. An aluminum foil 30 has been inserted between the steel sheets 12 and 14 having galvanized coatings 32 and 34 respectively, in the lap region 16. The laser beam melts the aluminum foil 30 and the galvanized coatings 32 and 34 as it proceeds in the direction 24, generating a liquid zinc-aluminum alloy region 36.

The aluminum foil 30 will melt at 660° C., which is below the boiling point of zinc at 906° C. Therefore, while the faying surfaces are heating up through the temperature range of 660-906° C., the zinc galvanized coatings 32 and 34 on the steel sheets 12 and 14 respectively, and the added aluminum foil 30, will liquify in contact with one another adjacent to, but separately from, the pool of molten steel 26. Hence, the zinc and aluminum can readily mix to form an alloy existing as a liquid film between the steel sheets 12 and 14.

The physical properties of the resultant liquid alloy, including its vapor pressure and boiling temperature, will be approximately in proportion to the atomic fraction of each element present in the liquid. For example, since the boiling temperature of aluminum at normal atmospheric pressure is 2450° C., the boiling temperature of a solution containing 70 atomic percent aluminum and 30 atomic percent zinc should be approximately 0.7(2450)+0.3(906)=1987° C. The physical properties of the zinc-aluminum alloy liquid 36 present in the faying surface region between the two steel sheets 12 and 14 to be welded can thus be pre-engineered. Preferably aluminum will comprise at least about 50% by weight and, more preferably, at least about 75% by weight of the added metal to be interposed between the zinc galvanized materials to be lap welded according to the invention. An adequately high boiling temperature for the alloy also can be ensured by selection of a suitable thickness of added aluminum foil material, in proportion to the amount of zinc galvanized coating present on the steel sheets 12 and 14.

Although the illustrated exemplary embodiment employs an aluminum foil, alternative embodiments may suitably provide an appropriate amount of aluminum over the surface area of the lap joint to be prepared to form a liquid alloy with the corresponding amount of zinc galvanizing coating on the steel sheets 12 and 14. For example, the aluminum can be in the form of a continuous or discontinuous coating previously applied over the zinc galvanized coating, continuous or discontinuous sheet, shims, or continuous or discontinuous powder interposed between the zinc layers 32 and 34 on the steel sheets 12 and 14 near the point of laser impact 22 and in the direction of laser beam motion 24. One preferred method of adding the aluminum layer 30 to the lap joint assembly is to coat an adherent film of aluminum particles onto the zinc galvanized sheet surfaces of one or both sheets using the Cold Spray Process as described in the following items, the entirety of which are incorporated herein by reference: J. Villafuerte, Welding Journal V. 84 No.5, May, 2005, pp. 24-29 and A. I. Kashirin, O. F. Klyuev and T. V. Buzdygar, U.S. Pat. No. 6,402,050, issued Jun. 11, 2002, entitled “Apparatus for gas-dynamic coating”.

During the progress of the welding operation, the molten steel pool 26 will be in contact with the liquid zinc-aluminum alloy formed in the faying interface, and a small amount of the liquid zinc-aluminum alloy 36 will dissolve into the molten steel pool 26. Although steel-aluminum alloys are undesirably brittle, the thickness of the aluminum-zinc liquid alloy 36 is very small, so that only negligible amounts of aluminum and zinc are added to the steel weld. Accordingly, the welding operations according to the present invention do not cause cracking or any other significant deleterious effects on the properties of the steel welds. It is important, however, to avoid the dissolution of excessive amounts of aluminum and zinc into the steel weld bead, to control potential deterioration in the weld quality.

### EXAMPLE 1

A series of experimental lap welds was made using a 4 kilowatt (kW) diode laser as the heat source. Two zinc coated steel sheets each having a thickness of 1 millimeter were tightly clamped together in a lap joint arrangement with a 0.025 mm thick aluminum foil inserted in the joint. Lap welds were consistently made without any weld pool surface disturbance or steel expulsion. Comparison experiments were performed in which a 0.025 mm thick copper foil was substituted for the aluminum foil, and welding was otherwise conducted under the conditions taught in U.S. Pat. No. 6,479,168. The resulting welds exhibited undesirable cracks.

### EXAMPLE 2

Another series of experimental lap welds was made with the same laser and same grade of steel sheets as in Example 1, but with the sheets previously locally coated by cold spraying of particulate aluminum in the vicinity of the intended welds to an approximate thickness of 100 micrometers. Tightly clamped lap joints were consistently made without process disruption.

### EXAMPLE 3

Further series of lap welds were made with the same steel specification and inserted aluminum foil as in Example 1, but with a 3 kW Nd:YAG laser as the moving heat source, producing similar improvement in welding process stability as found when using a diode laser.

While the present invention has been disclosed in a presently preferred context, it will be recognized that the present teachings may be adapted to a variety of contexts consistent with this disclosure and the claims that follow. For example, although the welding processes according to the present invention are desirably carried out by placing the steel sheets to be lap joined in a tightly clamped assembly, this tight assembly is not required. Other types of lasers, such as YAG and CO₂ lasers, can be used. Heating sources other than lasers can potentially be used. Although the exemplary embodiments have employed steel sheets, such steel sheets do not have to be flat or straight, and the processes according to the present invention are generally applicable to zinc galvanized steel materials to be lap welded. Lap welding as applied to materials that are not in a sheet form can also be carried out. Although the processes according to the present invention employ aluminum as the added element to form an alloy with the zinc in galvanized coatings on steel, other elements can additionally be present in both the galvanized coatings and in the aluminum material to be alloyed with the zinc, so long as the desired melting and boiling properties of the materials are maintained. Metal elements other than aluminum, including alloys, having physical properties suitable to melt significantly below the boiling point of zinc and to form an alloy with zinc, which alloy has a boiling temperature above the melting temperature of steel, can potentially also be used together with or instead of aluminum according to the present invention.

We claim:

1. An apparatus, comprising:
first and second steel members;
a coating comprising zinc on each of said first and second steel members;
a weld bonding together said first and second steel members in a lap region;
said lap region comprising an added metal comprising aluminum, wherein said metal is selected to have a melting temperature below the boiling temperature of zinc, so as to form a liquid alloy with zinc, which alloy has a boiling temperature above the melting temperature of steel.

2. The apparatus as defined in claim 1, in which at least about 50% by weight of said added metal is aluminum.

3. The apparatus as defined in claim 2, in which at least about 75% by weight of said added metal is aluminum.

4. The apparatus as defined in claim 1, in which said first and second steel members are steel sheets.

5. A process for forming a lap weld, comprising the following steps:
providing first and second steel members to be lap welded together, each of said steel members having a coating thereon comprising zinc;
defining first and second lap regions respectively of such first and second steel members to be welded together;
juxtaposing said first and second lap regions together;
interposing between said first and second lap regions an amount of an added metal sufficient to form an alloy with the zinc, said added metal comprising aluminum and being selected to have a melting temperature below the boiling temperature of zinc, so as to form a liquid alloy with zinc, which alloy has a boiling temperature above the melting temperature of steel; and
heating said lap regions to a temperature sufficient to melt said added metal, form said alloy comprising said added metal and zinc, and melt steel in said lap regions, whereby said metal substantially reacts with the zinc without dissolving in molten steel, and whereby said first and second steel members are welded together in said lap region.

6. The process as defined in claim 5, in which at least about 50% by weight of said added metal is aluminum.

7. The process as defined in claim 6, in which at least about 75% by weight of said added metal is aluminum.

8. The process as defined in claim 5, in which each of said first and second steel members is a steel sheet.

9. The process as defined in claim 5, in which said added metal is in the form of a foil, a powder, or a pre-applied coating.

10. The process as defined in claim 5, in which said heating is carried out by applying laser light to said lap region.

11. The process as defined in claim 5, in which said first and second steel members are tightly held together while said first and second steel members are being welded together.

12. A lap weld produced according to the process of claim 5.
